(19) United States
(12) Patent Application Publication
(10) Pub. No.: US 2018/0025858 A1
(43) Pub. Date: Jan. 25, 2018

(54) LIGHT EMITTING KEYSWITCH

(71) Applicant: DARFON ELECTRONICS CORP., Taoyuan City (TW)

(72) Inventors: Chin-Hung Lin, Taoyuan City (TW); Liang-Ta Yeh, Taoyuan City (TW)

(21) Appl. No.: 15/652,266

(22) Filed: Jul. 18, 2017

(30) Foreign Application Priority Data
Jul. 20, 2016 (TW) 105122806

(51) Int. Cl. H01H 13/02; H01H 13/20; H01H 13/04; H01H 13/14

(52) U.S. Cl. CPC H01H 13/023; H01H 13/14; H01H 13/20; H01H 13/04; H01H 2219/036; H01H 2233/07

(57) ABSTRACT

A light emitting keyswitch includes a board, a cap, a lifting mechanism disposed between the board and the cap, a membrane switch including first and second substrates, an LED, and a transparent hollow elastic body. The first substrate has a first outer surface and a first inner surface. The second substrate has a second outer surface and a second inner surface. A switch circuit is disposed between the first and second inner surfaces. A copper circuit is formed on the second inner surface. A hole is formed on the first substrate. The LED is disposed on the second substrate, passes through the hole and is coupled to the copper circuit. The transparent hollow elastic body is attached to the first outer surface for covering the LED and the hole and is located under the cap. When the cap is pressed, the lifting mechanism or the cap triggers the switch circuit.

### BACKGROUND OF THE INVENTION

### 1. Field of the Invention

The present invention relates to a light emitting keyswitch, and more specifically, to a light emitting keyswitch directly disposing an LED and a copper circuit for controlling the LED to emit light on a substrate of a membrane switch and utilizing a transparent hollow elastic body to cover the LED.

### 2. Description of the Prior Art

In general, a conventional light emitting of a keyswitch is as shown in FIG. 1. FIG. 1 is a cross-sectional diagram of a light emitting keyswitch 10 according to the prior art. As shown in FIG. 1, the light emitting keyswitch 10 includes a board 12, a membrane circuit board 14, a hollow elastic body 16, a light guide plate 18, a light source 20, and a cap 22. The membrane circuit board 14 is disposed on the board 12 and has a switch 15. The light guide plate 18 is disposed on the membrane circuit board 14 and has a hole structure 19 for containing the hollow elastic body 16. Accordingly, the hollow elastic body 16 could be elastically deformed to press the membrane circuit board 14 for triggering the switch 15 when the cap 22 is pressed by an external force, so that the light emitting keyswitch 10 could execute corresponding input functions. The light source 20 is disposed at a side of the light guide plate 18 for emitting light into the light guide plate 18. In such a manner, the light guide plate 18 could guide the light to be incident to the cap 22 for generating the lighting emitting effect.

However, the aforesaid lateral light emitting design could cause the uneven brightness and light leakage problems. Furthermore, since the aforesaid triggering design needs to elastically deform the hollow elastic body 16 in advance for triggering the switch 15, it decreases the triggering sensitivity of the light emitting keyswitch.

### SUMMARY OF THE INVENTION

The present provides a light emitting keyswitch. The light emitting keyswitch includes a board, a cap, a lifting mechanism, a membrane switch, an LED, and a transparent hollow elastic body. The lifting mechanism is disposed between the board and the cap. The cap is movable between a pressed position and a non-pressed position relative to the board via the lifting mechanism. The membrane switch includes first and second substrates. The first substrate has a first outer surface and a first inner surface. The second substrate has a second outer surface and a second inner surface. A switch circuit is disposed between the first inner surface and the second inner surface. A copper circuit is formed on the second inner surface. A hole is formed on the first substrate. The LED is disposed on the second substrate and coupled to the copper circuit for emitting light by control of the copper circuit. The LED passes through the hole. The transparent hollow elastic body is located under the cap. The bottom of the transparent hollow elastic body is attached to the first outer surface to cover the LED and the hole. When the cap is pressed to the pressed positon, the lifting mechanism or the cap triggers the switch circuit.

The present invention further provides a light emitting keyswitch. The light emitting keyswitch includes a board, a cap, a lifting mechanism, a membrane switch, an LED, a transparent hollow elastic body, and a protection layer. The lifting mechanism is disposed between the board and the cap. The cap is movable between a pressed position and a non-pressed position relative to the board via the lifting mechanism. The membrane switch includes first and second substrates. The first substrate has a first outer surface and a first inner surface. The second substrate has a second outer surface and a second inner surface. A switch circuit is disposed between the first inner surface and the second inner surface. A copper circuit is formed on the first inner surface. The LED is disposed on the first substrate and coupled to the copper circuit on the first outer surface for emitting light by control of the copper circuit. The transparent hollow elastic body is located under the cap. A bottom of the transparent hollow elastic body is attached to the first outer surface to cover the LED and the hole. The protection layer covers the first outer surface. When the cap is pressed to the pressed positon, the lifting mechanism or the cap triggers the switch circuit.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a cross-sectional diagram of a light emitting keyswitch according to the prior art.

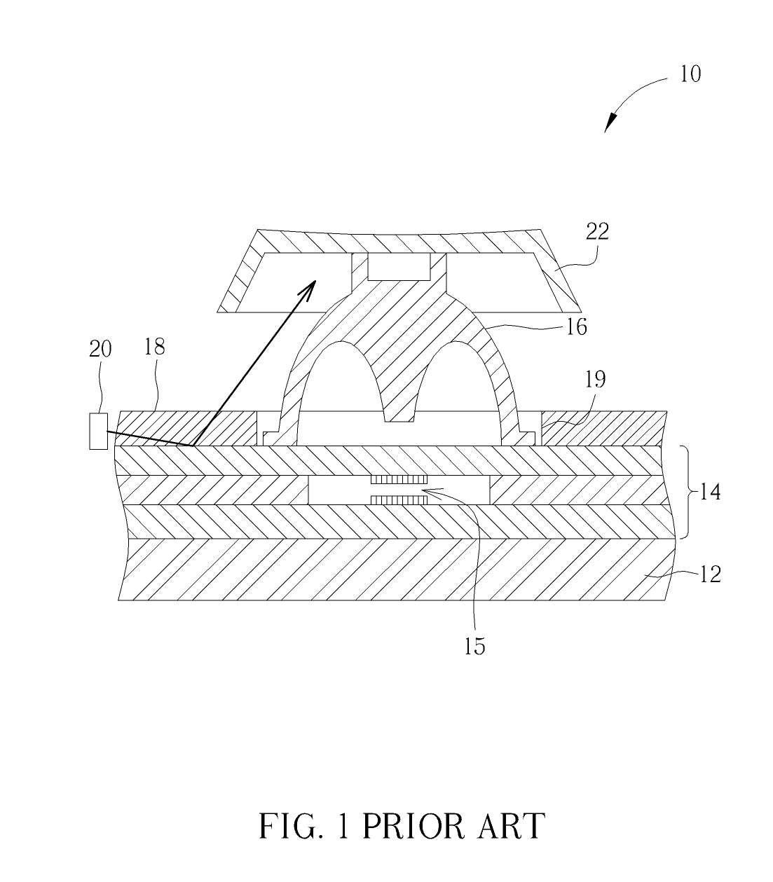

FIG. 2 is a schematic diagram of a light emitting keyswitch according to an embodiment of the present invention.

FIG. 3 is an exploded diagram of the light emitting keyswitch in FIG. 2.

FIG. 4 is a partial cross-sectional diagram of the light emitting keyswitch in FIG. 2 along a cross-sectional line A-A′.

FIG. 5 is a partial cross-sectional diagram of a cap in FIG. 4 being pressed to the pressed position.

FIG. 6 is a partial cross-sectional diagram of a light emitting keyswitch according to another embodiment of the present invention.

FIG. 7 is a partial cross-sectional diagram of the cap in FIG. 6 being pressed to a pressed position.

### DETAILED DESCRIPTION

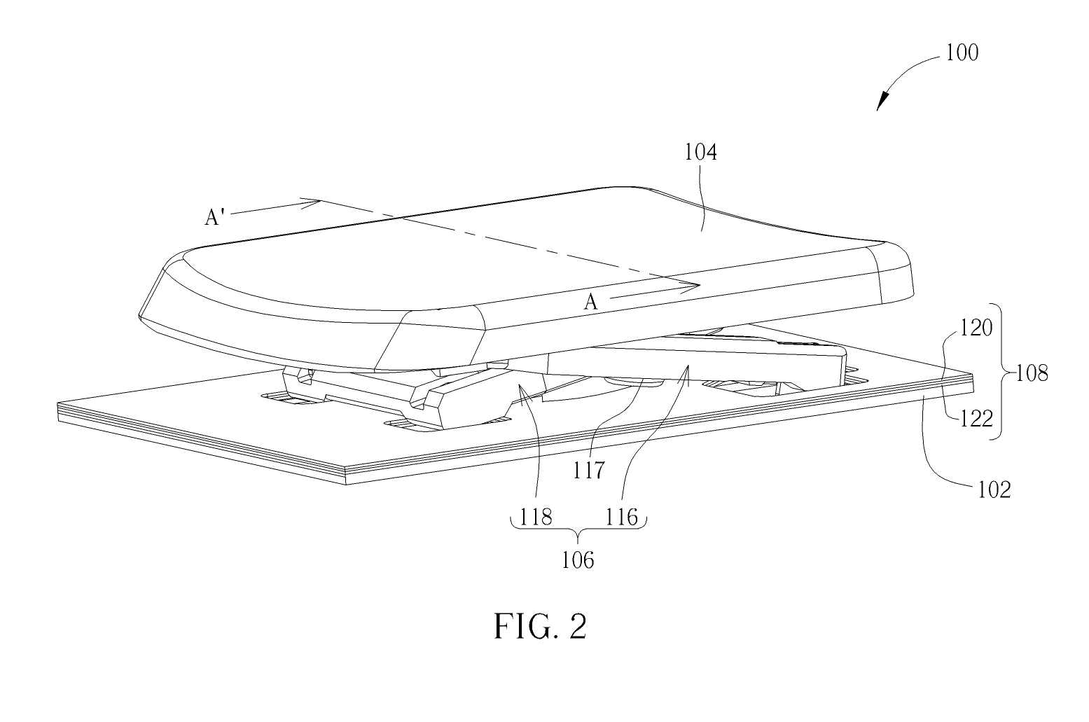

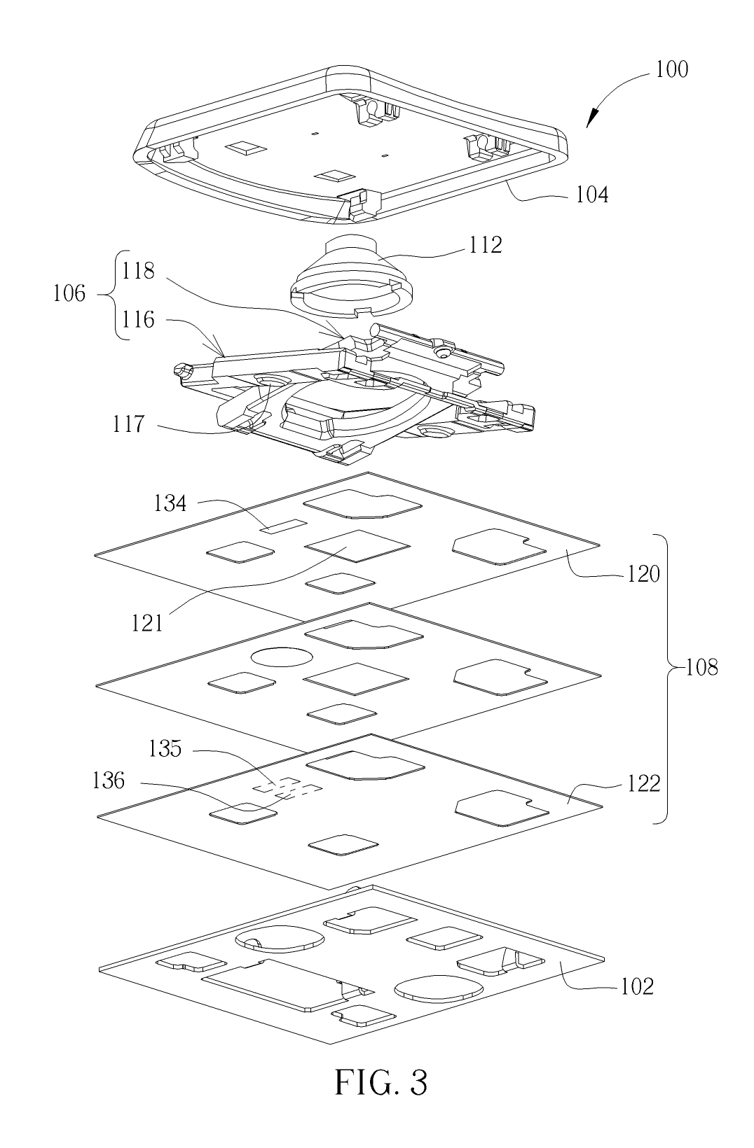

Please refer to FIG. 2 and FIG. 3. FIG. 2 is a schematic diagram of a light emitting keyswitch 100 according to an embodiment of the present invention. FIG. 3 is an exploded diagram of the light emitting keyswitch 100 in FIG. 2. The light emitting keyswitch 100 could be applied to a portable electronic device with a foldable mechanism composed of an upper cover and a lower casing (e.g. notebook or foldable keyboard device) for a user to press to execute corresponding input functions, but not limited thereto. As shown in FIG. 2 and FIG. 3, the light emitting keyswitch 100 includes a board 102, a cap 104, a lifting mechanism 106, a membrane switch 108, an LED (Light Emitting Diode) 110, and a transparent hollow elastic body 112. The lifting mechanism 106 is disposed between the board 102 and the cap 104. The cap 104 is movable between a pressed position and a non-pressed position relative to the board 102 via the lifting mechanism 106. To be more specific, in this embodiment, the lifting mechanism 106 could preferably be a scissor support structure and include a first support member 116 and a second support member 118. The first support member 116 is movably connected to the cap 104 and the board 102. The second support member 118 is movably connected to the cap 104 and the board 102 and pivotally intersects with the first support member 116. Accordingly, the cap 104 could be movable between the pressed position and the non-pressed position relative to the board 102 via scissor connection between the first support member 116 and the second support member 118.

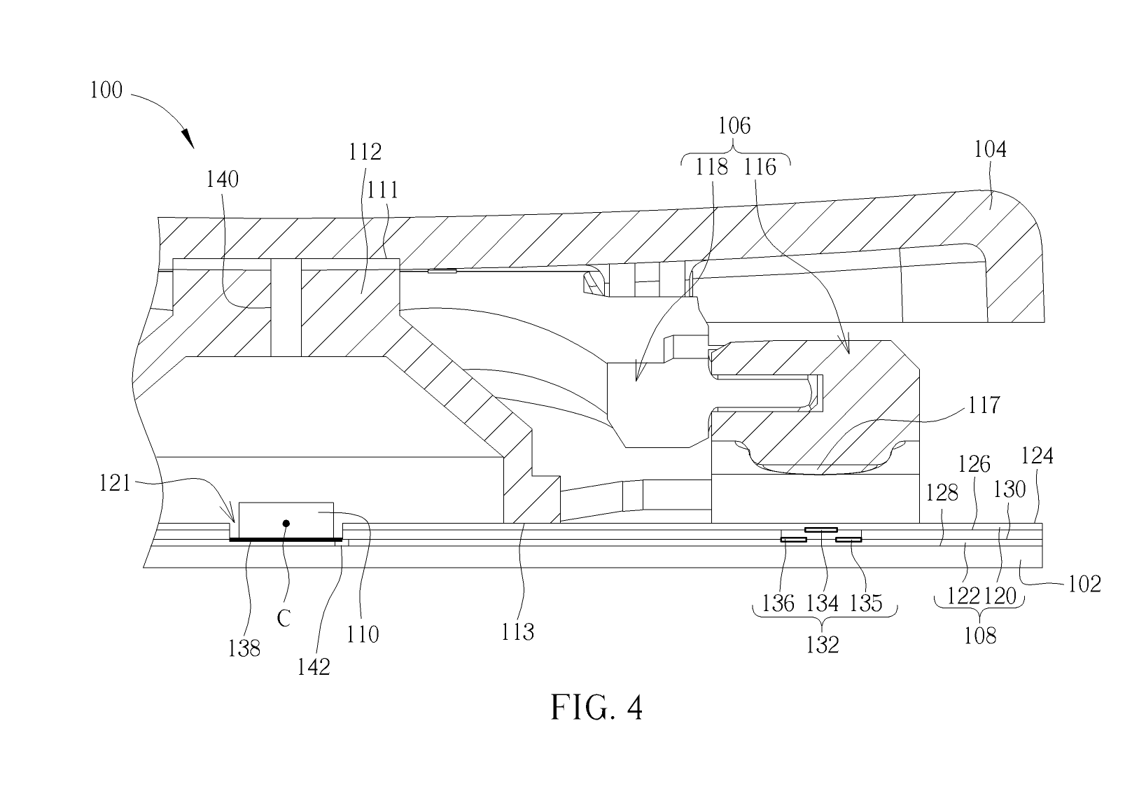

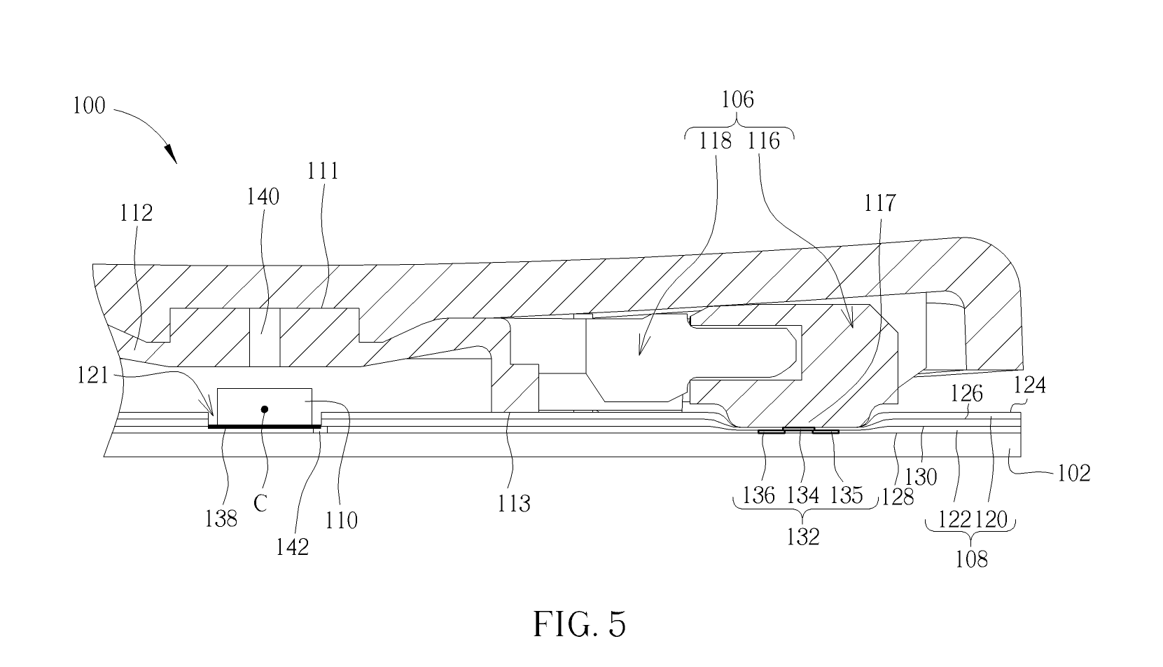

The triggering design of the light emitting switch 100 could be as shown in FIG. 3, FIG. 4, and FIG. 5. FIG. 4 is a partial cross-sectional diagram of the light emitting keyswitch 100 in FIG. along a cross-sectional line A-A′. FIG. 5 is a partial cross-sectional diagram of the cap 104 in FIG. 4 being pressed to the pressed position. As shown in FIG. 3, FIG. 4, and FIG. 5, the membrane switch 108 could preferably be a membrane circuit board and be disposed at a side of the board 102 facing the cap 104. The membrane switch 108 includes a first substrate 120 and a second substrate 122. The first substrate 120 and the second substrate 122 could preferably be made of PET (polyethylene terephthalate) material (but not limited thereto). The first substrate 120 has a first outer surface 124 and a second inner surface 126. The second substrate 122 has a second outer surface 128 and a second inner surface 130. At least one switch circuit 132 (one shown in FIG. 4, but not limited thereto) is disposed between the first inner surface 126 and the second inner surface 130. In this embodiment, the light emitting keyswitch 100 could preferably adopt a support triggering design (but not limited thereto, meaning that the present invention could adopt a cap triggering design in another embodiment, such as utilizing a protruding point of a cap to trigger a corresponding switch circuit on a membrane switch, and the related description could be reasoned by analogy according to this embodiment and omitted herein) . To be more specific, as shown in FIG. 4, the first support member 116 could have a protruding point 117 formed toward the switch circuit 132. The switch circuit 132 could include a first conduction point 134, a second conduction point 135, and a third conduction point 136. The first conduction point 134 could preferably be formed on the first inner surface 126 of the first substrate 120 by a silver paste printing process. The second conduction point 135 and the third conduction point 136 could preferably be formed on the second inner surface 130 of the second substrate 122 by a copper etching process. The first conduction point 134 is spaced from and opposite to the second conduction point 135 and the third conduction point 136. Accordingly, when the cap 104 is pressed by an external force, the light emitting keyswitch 100 could conduct the first conduction point 134 with the second conduction point 135 and the third conduction point 136 by utilizing the protruding point 117 to press the switch circuit 132, so as to generate corresponding triggering signals.

To be noted, the aforesaid triggering design could be applied to the second support member 118 (the related description could be reasoned by analogy according to this embodiment and omitted herein), and where the first conduction point 134, the second conduction point 135, and the third conduction point 136 are formed is not limited to this embodiment. For example, in another embodiment, the present invention could adopt the design that the first conduction point 134 is formed on the second inner surface 130 of the second substrate 122 by a silver paste printing process and the second conduction point 135 and the third conduction point 136 are formed on the first inner surface 126 of the first substrate 120 by a copper etching process.

As for the light emitting design of the light emitting keyswitch 100, it could be as shown in FIG. 3, FIG. 4, and FIG. 5. A copper circuit 138 is formed on the second inner surface 130. A hole 121 is formed on the first substrate 120. The LED 110 is disposed on the second substrate 122 and coupled to the copper circuit 138 on the second inner surface 130 for emitting light by control of the copper circuit 138. The LED 110 passes through the hole 121 and a bottom 113 of the transparent hollow elastic body 112 is attached to the first outer surface 124. The transparent hollow elastic body 112 covers the LED 110 and the hole 121. In this embodiment, the bottom 113 of the transparent hollow elastic body 112 could have a central point C, and the LED 110 and the hole 121 could substantially be located at the central point C. In such a manner, via the design that the LED 110 is located at the central point C of the bottom 113 of the transparent hollow elastic body 112 (instead of the lateral light emitting design of the prior art), the LED 100 could emit light by control of the copper circuit 138 (compared with a silver paste circuit, a copper circuit could have a constant resistance), and the transparent hollow elastic body 112 covers the LED 110, the light emitting keyswitch 100 provided by the present invention can solve the uneven brightness and light leakage problems aforementioned in the prior art.

In practical application, as shown in FIG. 4 and FIG. 5, a top 111 of the transparent hollow elastic body 112 could have a first vent hole 140 for exhausting internal air of the transparent hollow elastic body 112 when the transparent hollow elastic body 112 is pressed by the cap 104. Via the aforesaid design that the vent hole is formed on a higher position of the transparent hollow elastic body, the present invention can surely prevent foreign objects or liquid (e.g. water) from entering the transparent hollow elastic body via the vent hole to damage the LED and the circuit. Furthermore, as shown in FIG. 4 and FIG. 5, in this embodiment, the second substrate 122 could have a second vent hole 142 located under the transparent hollow elastic body 112 for increasing the exhaust efficiency of the light emitting keyswitch 100.

Via the aforesaid designs, when the cap 104 is pressed from the non-pressed position as shown in FIG. 4 to the pressed position as shown in FIG. 5 by the external force, the first support member 116 and the second support member 118 could pivot relatively with downward movement of the cap 104, to make the protruding pint 117 of the first support member 116 press the switch circuit 132, so that the first conduction point 134 could contact the second conduction point 135 and the third conduction point 136 to generate input signals for executing corresponding input functions. In such a manner, via the design that the protruding point 117 of the first support member 116 directly presses the membrane switch 108 for triggering the switch circuit 132, the present invention can greatly improve the triggering sensitivity and the tactile feedback of the light emitting keyswitch, to solve the prior art problem that the hollow elastic body needs to elastically deform in advance for triggering the membrane circuit board so as to decrease the triggering sensitivity of the light emitting keyswitch. Furthermore, since the present invention adopts the design that the LED 110 and the copper circuit 138 for controlling the LED 110 to emit light are directly disposed on the second substrate 122 of the membrane switch 108 instead of the prior art design that an extra LED circuit board needs to be disposed in the light emitting keyswitch, the present invention can efficiently reduce the overall board thickness of the light emitting keyswitch, so as to be advantageous to the thinning design of the light emitting keyswitch.

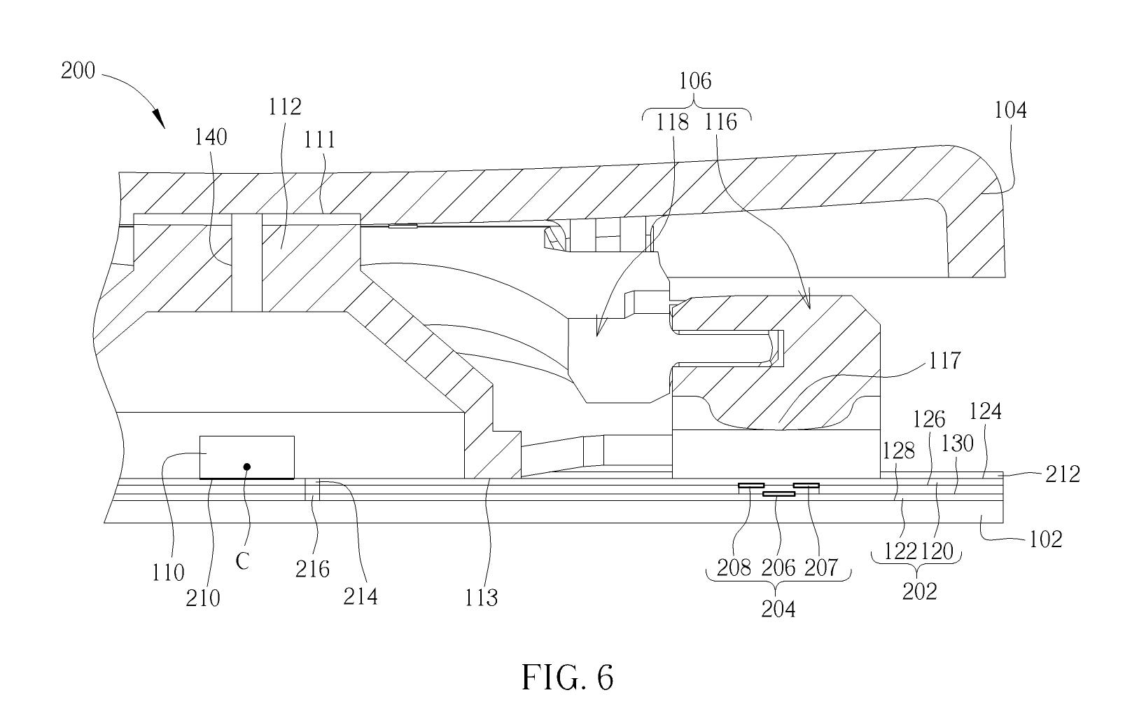

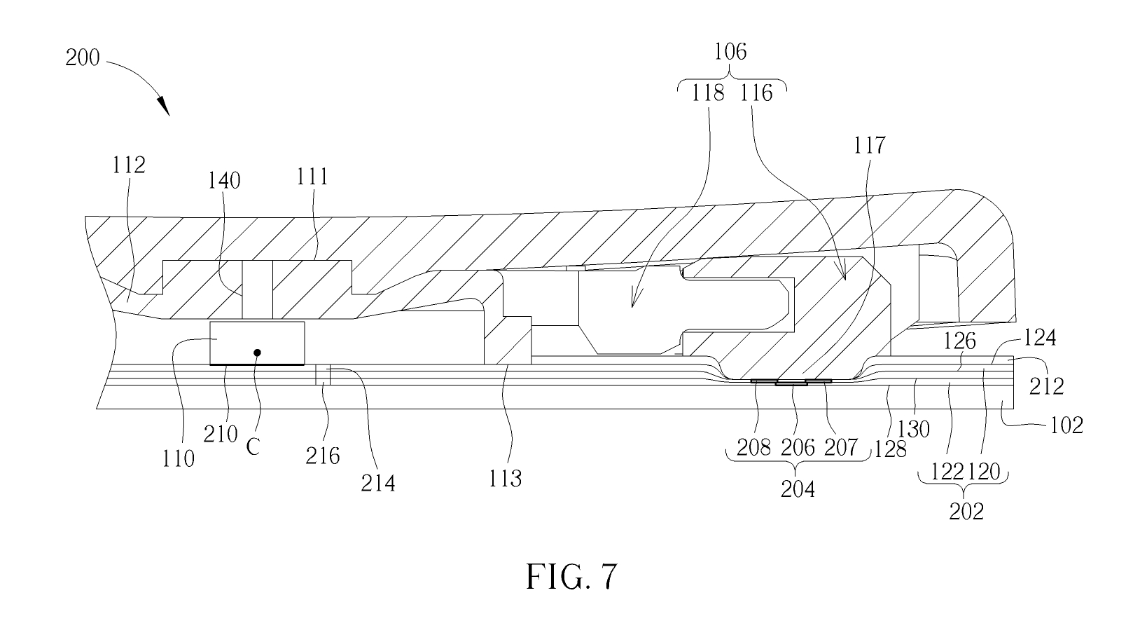

It should be mentioned that the present invention could adopt the design that the circuit for controlling the LED to emit light is directly formed on the outer surface of the membrane switch facing the cap in another embodiment. For example, please refer to FIG. 6 and FIG. 7. FIG. 6 is a partial cross-sectional diagram of a light emitting keyswitch 200 according to another embodiment of the present invention. FIG. 7 is a partial cross-sectional diagram of the cap 104 in FIG. 6 being pressed to a pressed position. Components both mentioned in this embodiment and the aforesaid embodiment represent components with similar structures or functions. The major difference between the light emitting keyswitch 200 and the light emitting keyswitch 100 is the layout of the LED and the circuit.

As shown in FIG. 6 and FIG. 7, the light emitting keyswitch 200 includes the board 102, the cap 104, the lifting mechanism 106, a membrane switch 202, the LED 110, and the transparent hollow elastic body 112. The membrane switch 202 could preferably be a membrane circuit board and be disposed at a side of the board 102 facing the cap 104. The membrane switch 108 includes the first substrate 120 and the second substrate 122. The first substrate 120 has the first outer surface 124 and a second inner surface 126. The second substrate 122 has the second outer surface 128 and the second inner surface 130. At least one switch circuit 204 (one shown in FIG. 6, but not limited thereto) is disposed between the first inner surface 126 and the second inner surface 130. The switch circuit 204 could include a first conduction point 206, a second conduction point 207, and a third conduction point 208. The first conduction point 206 could preferably be formed on the second inner surface 130 of the second substrate 122 by a silver paste printing process. The second conduction point 207 and the third conduction point 208 could preferably be formed on the first inner surface 126 of the first substrate 120 by a copper etching process. The first conduction point 206 is spaced from and opposite to the second conduction point 207 and the third conduction point 208. Accordingly, when the cap 104 is pressed by an external force, the light emitting keyswitch 200 could make the second conduction point 207 and the third conduction point 208 contact the first conduction point 206 by utilizing the protruding point 117 to press the switch circuit 204, so as to generate corresponding triggering signals.

To be noted, where the first conduction point 206, the second conduction point 207, and the third conduction point 208 are formed is not limited to the aforesaid embodiment. For example, in another embodiment, the present invention could adopt the design that the first conduction point 206 is formed on the first inner surface 126 of the first substrate 120 by a silver paste printing process and the second conduction point 207 and the third conduction point 208 are formed on the second inner surface 130 of the second substrate 122 by a copper etching process.

As for the light emitting design of the light emitting keyswitch 200, it could be as shown in FIG. 6 and FIG. 7. A copper circuit 210 is formed on the first outer surface 124. The LED 110 is disposed on the first substrate 120 and coupled to the copper circuit 210 on the first outer surface 124 for emitting light by control of the copper circuit 210. The bottom 113 of the transparent hollow elastic body 112 is attached to the first outer surface 124, and the transparent hollow elastic body 112 covers the LED 110. In this embodiment, the bottom 113 of the transparent hollow elastic body 112 could have the central point C, and the LED 110 could substantially be located at the central point C. In such a manner, via the design that the LED 110 is located at the central point C of the bottom 113 of the transparent hollow elastic body 112 (instead of the lateral light emitting design of the prior art), the LED 100 could emit light by control of the copper circuit 210 (compared with a silver paste circuit, a copper circuit could have a constant resistance), and the transparent hollow elastic body 112 covers the LED 110, the light emitting keyswitch 200 provided by the present invention can solve the uneven brightness and light leakage problems aforementioned in the prior art. Furthermore, as shown in FIG. 6 and FIG. 7, the light emitting keyswitch 200 further includes a protection layer 212. The protection layer 212 covers the first outer surface 124 for protecting the copper circuit 210 and generating the ESD (Electrostatic Discharge) resistance, dust proof, and water proof effects.

Via the aforesaid designs, when the cap 104 is pressed from a non-pressed position as shown in FIG. 6 to the pressed position as shown in FIG. 7 by the external force, the first support member 116 and the second support member 118 could pivot relatively with downward movement of the cap 104, to make the protruding pint 117 of the first support member 116 press the switch circuit 204, so that the second conduction point 207 and the third conduction point 208 could contact the first conduction point 206 to generate input signals for executing corresponding input functions.

In practical application, as shown in FIG. 6 and FIG. 7, in addition to the design that the top 111 of the transparent hollow elastic body 112 has the first vent hole 140, in this embodiment, the first substrate 120 could have a second vent hole 214 located under the transparent hollow elastic body 112, and the second substrate 122 could have a third vent hole 216 corresponding to the second vent hole 214. Accordingly, when the transparent hollow elastic body 112 is pressed by the cap 104, internal air of the transparent hollow elastic body 112 could further be exhausted by the second vent hole 214 and the third vent hole 216, so as to efficiently improve the exhaust efficiency of the light emitting keyswitch 200. As for the other related description for the components of the light emitting keyswitch 200, it could be reasoned by analogy according to the aforesaid embodiment and omitted herein.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A light emitting keyswitch comprising:
a board;
a cap;
a lifting mechanism disposed between the board and the cap, the cap being movable between a pressed position and a non-pressed position relative to the board via the lifting mechanism;
a membrane switch comprising first and second substrates, the first substrate having a first outer surface and a first inner surface, the second substrate having a second outer surface and a second inner surface, a switch circuit being disposed between the first inner surface and the second inner surface, a copper circuit being formed on the second inner surface, a hole being formed on the first substrate;
an LED disposed on the second substrate and coupled to the copper circuit for emitting light by control of the copper circuit, the LED passing through the hole; and
a transparent hollow elastic body located under the cap, a bottom of the transparent hollow elastic body being attached to the first outer surface to cover the LED and the hole;
wherein when the cap is pressed to the pressed positon, the lifting mechanism or the cap triggers the switch circuit.

2. The light emitting keyswitch of claim 1, wherein the switch circuit comprises a first conduction point, a second conduction point, and a third conduction point, the first conduction point is formed by a silver paste printing process, the second conduction point and the third conduction point are formed by a copper etching process, the first conduction point is spaced from and opposite to the second conduction point and the third conduction point, and when the cap is pressed to the pressed positon, the lifting mechanism or the cap makes the first conduction point contact the second conduction point and the third conduction point to conduct the switch circuit.

3. The light emitting keyswitch of claim 2, wherein the first conduction point is disposed on the first inner surface of the first substrate, and the second conduction point and the third conduction point are disposed on the second inner surface of the second substrate.

4. The light emitting keyswitch of claim 1, wherein the first substrate and the second substrate are made of PET (polyethylene terephthalate) material.

5. The light emitting keyswitch of claim 1, wherein a top of the transparent hollow elastic body has a first vent hole.

6. The light emitting keyswitch of claim 1, wherein the second substrate has a second vent hole located under the transparent hollow elastic body.

7. The light emitting keyswitch of claim 1, wherein the bottom of the transparent hollow elastic body has a central point, and the LED and the hole are substantially located at the central point.

8. The light emitting keyswitch of claim 1, wherein the lifting mechanism is a scissor support structure and has a first support member and a second support member, and at least one of the first support member and the second support member has a protruding point for triggering the switch circuit.

9. A light emitting keyswitch comprising:
a board;
a cap;
a lifting mechanism disposed between the board and the cap, the cap being movable between a pressed position and a non-pressed position relative to the board via the lifting mechanism;
a membrane switch comprising first and second substrates, the first substrate having a first outer surface and a first inner surface, the second substrate having a second outer surface and a second inner surface, a switch circuit being disposed between the first inner surface and the second inner surface, a copper circuit being formed on the first inner surface;
an LED disposed on the first substrate and coupled to the copper circuit on the first outer surface for emitting light by control of the copper circuit;
a transparent hollow elastic body located under the cap, a bottom of the transparent hollow elastic body being attached to the first outer surface to cover the LED and the hole; and
a protection layer covering the first outer surface;
wherein when the cap is pressed to the pressed positon, the lifting mechanism or the cap triggers the switch circuit.

10. The light emitting keyswitch of claim 9, wherein the switch circuit comprises a first conduction point, a second conduction point, and a third conduction point, the first conduction point is formed by a silver paste printing process, the second conduction point and the third conduction point are formed by a copper etching process, the first conduction point is spaced from and opposite to the second conduction point and the third conduction point, and when the cap is pressed to the pressed positon, the lifting mechanism or the cap makes the first conduction point contact the second conduction point and the third conduction point to conduct the switch circuit.

11. The light emitting keyswitch of claim 10, wherein the first conduction point is disposed on the second inner surface of the second substrate, and the second conduction point and the third conduction point are disposed on the first inner surface of the first substrate.

12. The light emitting keyswitch of claim 9, wherein the first substrate and the second substrate are made of PET material.

13. The light emitting keyswitch of claim 9, wherein a top of the transparent hollow elastic body has a first vent hole.

14. The light emitting keyswitch of claim 9, wherein the first substrate has a second vent hole located under the transparent hollow elastic body.

15. The light emitting keyswitch of claim 14, wherein the second substrate has a third vent hole corresponding to the second vent hole.

16. The light emitting keyswitch of claim 9, wherein the lifting mechanism is a scissor support structure and has a first support member and a second support member, and at least one of the first support member and the second support member has a protruding point for triggering the switch circuit.
